(19) United States
(12) Patent Application Publication
(10) Pub. No.: US 2007/0129954 A1
(43) Pub. Date: Jun. 7, 2007

(54) Mapping and quality control system and method for the distribution of flyers, circulars and the like

(76) Inventor: Benoit Dessureault, Kirkland (CA)

Correspondence Address: MEYERTONS, HOOD, KIVLIN, KOWERT & GOETZEL, P.C., P.O. BOX 398, AUSTIN, TX, 78767-0398, US

(21) Appl. No.: 11/291,485

(22) Filed: Dec. 1, 2005

(51) Int. Cl. G06Q 99/00; G06F 15/02; G06F 9/46

(52) U.S. Cl. 705/1; 705/9

(57) ABSTRACT

A mapping and quality control system and method for the distribution of flyers, circulars and other such hardcopy media is disclosed. For example, a Web based system for displaying location-specific market data for an area in view of targeting a delivery of hardcopy media via a carrier in the area is comprised of at least one database, comprising the market data and a number of distribution zones, a data processor for mapping the market data and the distribution zones on a map and, a communicatively linked Web server and client for displaying the map via a client output device. Further, an exemplary system for use in providing a mapped quality control of objects delivered at locations along a distribution route comprises a portable positioning device for acquiring a QC position of at least one object delivery location, a data processor adapted to assign a positive delivery status marker thereto and, an output device for displaying the marker on a map of an area encompassing the distribution route. Methods and computer readable programs for implementing such systems are also disclosed.

### FIELD OF THE INVENTION

The present invention relates to mapping and quality control systems and methods for the distribution of flyers, circulars and the like. The present invention relates more particularly to a system and method for the Web mapping and quality control of a targeted distribution of circulars, flyers, and the like.

### BACKGROUND OF THE INVENTION

Targeted advertising is commonly distributed to consumers through e-mail, telemarketing and by regular mail from a number of commercial entities seeking to advertise or promote their products and/or services to potential customers. Such advertising is generally based on a number of demographic and/or geographic parameters acquired either from a central data source, such as national census demographics and the like, or from a number of cooperative retail establishments acquiring purchasing and personal customer information from their customers when a customer makes a purchase. Other methods of data acquisition, namely relying on Web purchases and registered access to Web services, may also be used to establish potential customer lists.

In order to plan and prepare targeted regional and/or local advertising campaigns based on acquired customer information, such information may be regrouped and mapped by geographic regions, generally mapping customer data and consumer activity using any one of customer zip codes, postal codes or phone area codes. These maps can then be printed and distributed to plan various targeted market mailing campaigns.

However, known retail data mapping techniques and services are generally limited with regard to data availability and accessibility as well as to the methods of targeted advertising capable of benefiting from provided data mapping formats. Namely, though certain Web portals have been developed to provide end users access to various demographics information, such information is generally provided on a large regional scale and used for regional customer analyses to prepare mass mailing lists and advertising campaigns. Small scale operations and advertising mediums are thus not well suited for such services. Also, known market analysis services generally do not provide means for evaluating the reach of targeted campaigns. It is usually impossible to verify whether the targeted audience received and/or was exposed to the marketing media and when such exposure took place.

### SUMMARY OF THE INVENTION

In order to address the above and other drawbacks of known techniques, it is an aim of the present invention to provide a Web mapping system and method for providing end users thereof access to geographically aggregated market data.

It is a further aim of the present invention to provide a mapping system and method for geographically mapping market data used to gear and orient the hand distribution of hardcopy media.

It is a still further aim of the present invention to provide a quality control system and method for monitoring the delivery of hardcopy media.

More specifically, in accordance with the present invention, there is provided a method for providing a mapped quality control of objects delivered at locations along a distribution route, the method comprising the steps of:
acquiring a QC position of at least one object delivery location using a portable positioning device;
assigning a positive delivery status marker to said QC position; and
displaying said marker on a map of an area encompassing the distribution route.

Also in accordance with the present invention, there is provided a system for use in providing a mapped quality control of objects delivered at locations along a distribution route, the system comprising a portable positioning device for acquiring a QC position of at least one object delivery location, a data processor, having communicative access to the QC position, adapted to assign a positive delivery status marker thereto and, an output device for displaying the marker on a map of an area encompassing the distribution route.

Further in accordance with the present invention, there is provided a computer-readable storage medium having a computer-readable program embodied therein for directing operations of a computer system comprising a processor, a storage device and an output device. The computer-readable program comprises instructions for operating the computer system to provide a mapped quality control of objects delivered at locations along a distribution route. The instructions comprise maintaining at least one database on the storage device, the database comprising at least one QC entry comprising a QC position, each QC entry indicating a delivery of at least one of the objects at a location represented by the QC position, assigning a positive delivery status marker to each QC entry using the processor and, displaying each of the markers on a map of an area encompassing the distribution route via the output device.

Still further in accordance with the present invention, there is provided a computer-readable storage medium having a computer-readable program embodied therein for directing operations of a Web based computer system comprising at least one processor, a storage device, a Web server and a Web client communicatively linked to the server. The computer-readable program comprises instructions for operating the system to provide a mapping of location-specific market data for an area in view of targeting a delivery of hardcopy media via a carrier in the area. The instructions comprise maintaining at least one database on the storage device, the database comprising a first series of data entries and a second series of data entries, each of the first series of entries comprising market data having a value and a location and each of the second series of entries comprising a distribution zone, the distribution zone being sized to encompass a respective carrier distribution route for the delivery. The instructions further comprise mapping the first series of entries and the second series of entries on a map of the area, wherein the mapping of each of the first series of entries comprises generating a semaphore representative of the entry value and placing the semaphore on the map at the entry location and, providing the client access to the map via the server to be displayed thereby via a client output device.

Still further in accordance with the present invention, there is provided a Web based system for displaying location-specific market data for an area in view of targeting a delivery of hardcopy media via a carrier in the area, the system comprising at least one database, the database comprising a first series of data entries and a second series of data entries, each of the first series of entries comprising market data having a value and a location and each of the second series of entries comprising a distribution zone, the distribution zone being sized to encompass a respective carrier distribution route for the delivery. The system further comprises a data processor for mapping the first series of entries and the second series of data entries on a map of the area, wherein the mapping of each of the first series of data entries comprises generating a semaphore representative of the entry value and placing the semaphore on the map at the entry location. The system also comprises a Web server for providing access to the map and, a Web client, communicatively linked to the server, for displaying the map via a client output device.

Other aims, objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic of a Web mapping and quality control system, implemented by a distributor of hardcopy media and accessible via a Web client by a sponsor of the hardcopy media, in accordance with an illustrative embodiment of the present invention;

FIGS. 2A and 2B are schematics of a host system and a quality control device of the Web mapping and quality control system of FIG. 1;

FIG. 3A is an exemplary screen display of an interactive Web mapping site generated by the system of FIG. 1 and accessed by the sponsor via a Web client; the Web mapping site providing herein a regional mapping of potential customer information and data related thereto of interest to the sponsor for planning a distribution of the hardcopy media;

FIG. 3B is an enlarged map window of the screen display of FIG. 3A;

FIG. 4 is a flow chart illustrating distributor and sponsor actions in implementing and using the Web mapping and quality control system of FIG. 1;

FIG. 5 is a flow chart illustrating distributor actions in implementing a quality control process for a distribution of hardcopy media, using the Web mapping and quality control system of FIG. 1;

FIG. 6 is a flow chart illustrating operable instructions comprised in a Web mapping and quality control application for the operation of the Web mapping and quality control system of FIG. 1;

FIG. 7 is an exemplary screen display of a login page for accessing the Web mapping site of FIG. 2;

FIG. 8A is an exemplary screen display of the interactive Web mapping site of FIG. 2, the Web mapping site providing herein a regional mapping of a distribution project based on the potential customer information and data;

FIG. 8B is an enlarged map window of the screen display of FIG. 8A;

FIG. 9A is an exemplary screen display of the interactive Web mapping site of FIG. 2, the Web mapping site providing herein a zoomed-in zonal mapping of the potential customer information and data;

FIG. 9B is an enlarged map window of the screen display of FIG. 9A;

FIG. 10A is an exemplary screen display of the interactive Web mapping site of FIG. 9A, the Web mapping site additionally providing herein access to quality control waypoints obtained for selected distribution routes via a remote quality control device, as illustrated in FIG. 1;

FIG. 10B is an enlarged map window of the screen display of FIG. 10A;

FIG. 11A is an exemplary screen display of the interactive Web mapping site of FIG. 9A, the Web mapping site additionally providing herein access to quality control tracking obtained for selected distribution routes via a remote quality control device, as illustrated in FIG. 1; and

FIG. 11B is an enlarged map window of the screen display of FIG. 11A;

FIG. 12 is an exemplary screen display of a printable map generated from the Web mapping site of FIG. 9A and, a print-function dialog automatically activated by the Web client upon generation of the printable map for printing the map.

### DESCRIPTION OF ILLUSTRATIVE EMBODIMENTS

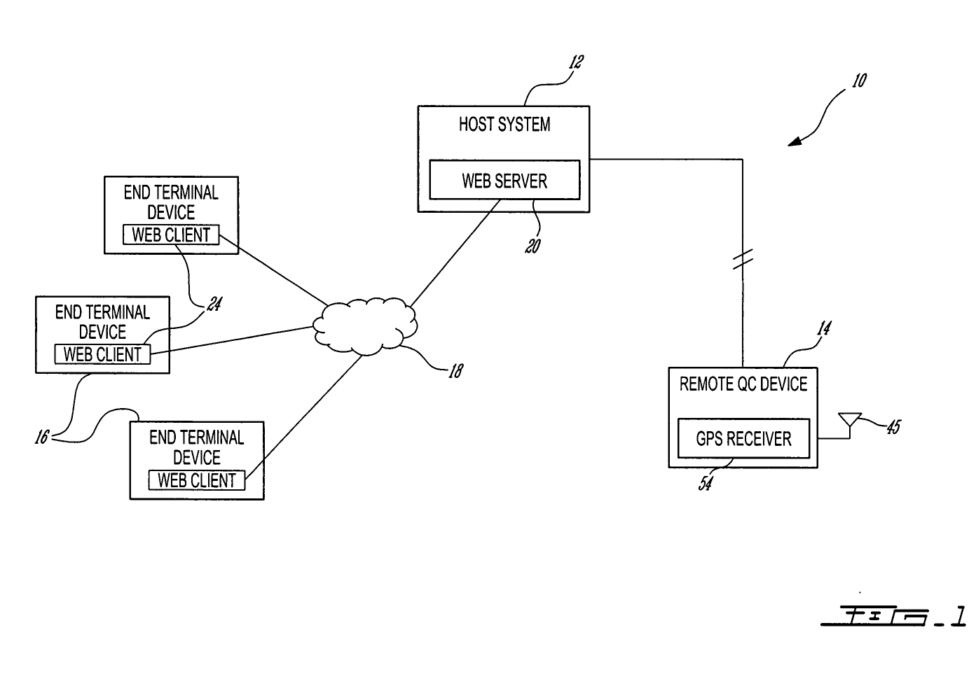

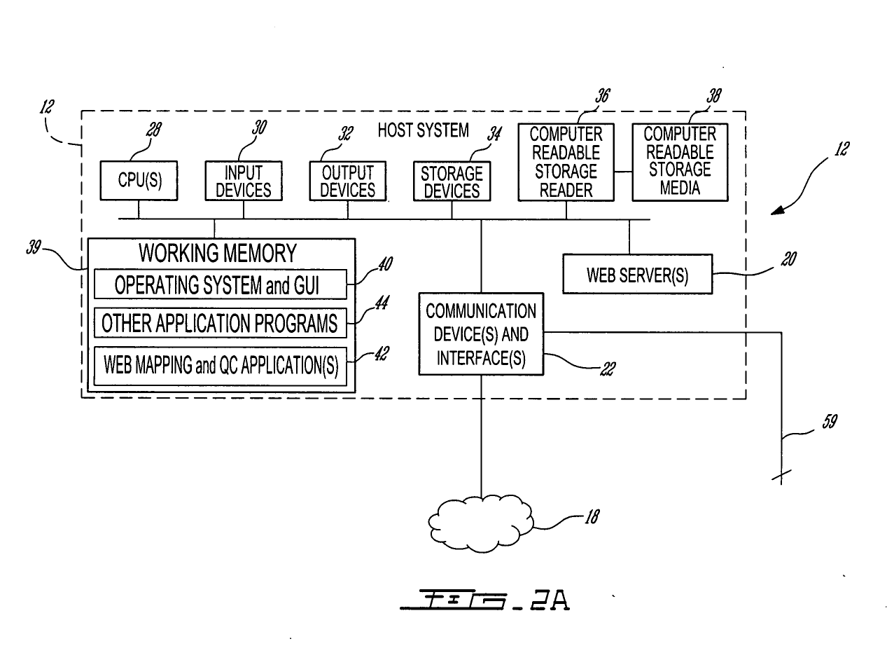

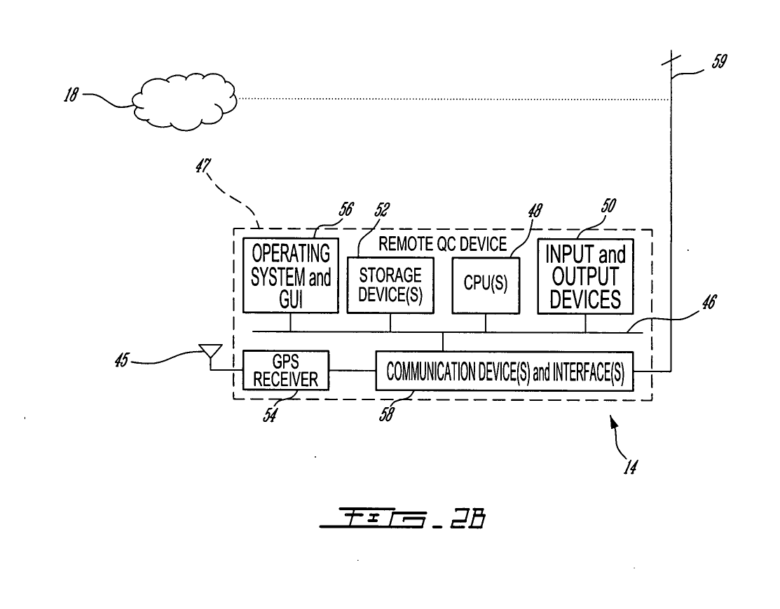

Referring now to FIGS. 1, 2A and 2B, in accordance with an illustrative embodiment of the present invention, a Web mapping and quality control (QC) system, generally referred to using the numeral 10, will now be described. The Web mapping and QC system 10 is illustratively comprised of a host system 12 for hosting a number of Web mapping and QC services and, one or more remote QC devices as in 14 for acquiring the QC data used by the host system 12 to provide the QC services.

To provide the Web mapping and QC services, the host system 12 is generally adapted to communicate with at least one remote end terminal device as in 16 through a landline or wireless communication network 18. For instance, the various Web services may be provided by the host system 12 via a Web server 20 and an associated communication device and interface 22 and, accessed over the communication network 18 by a Web client 24 stored on one of the end terminal devices 16, such as an internet enabled personal computer or the like. Accordingly, the various map and QC products and services, described further hereinbelow, may be displayed and accessed via a client output device such as a display screen, a printer and the like.

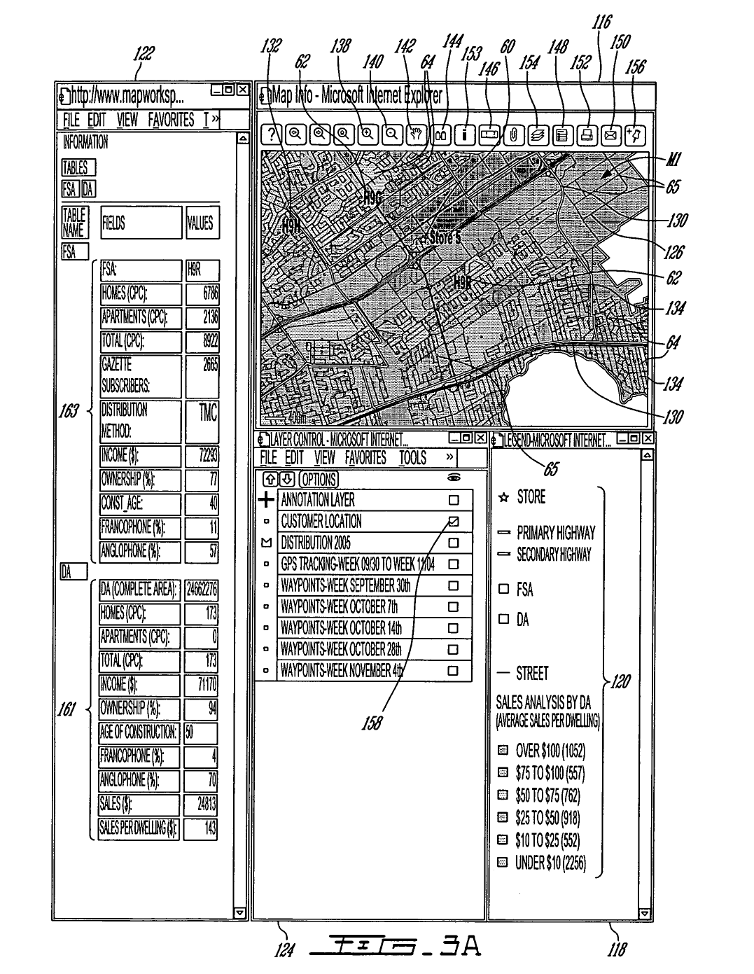

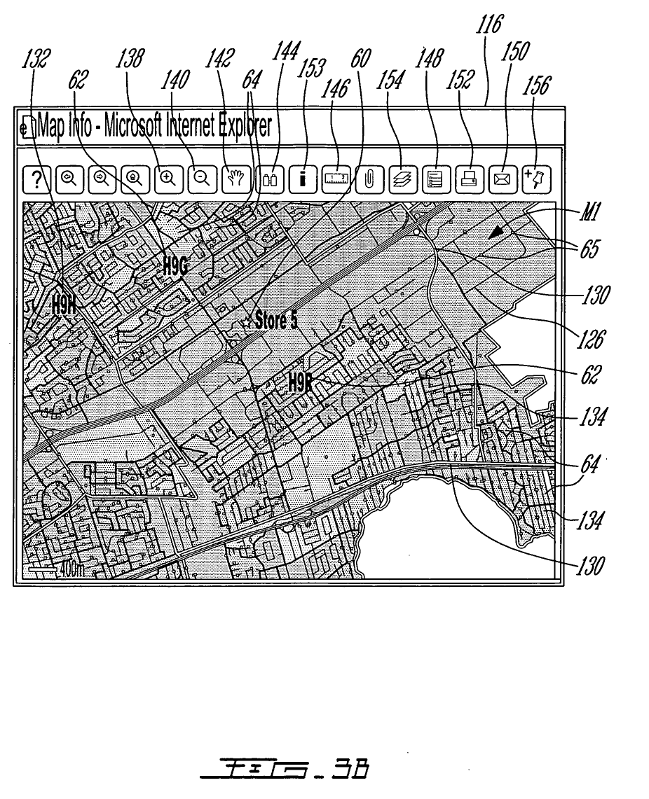

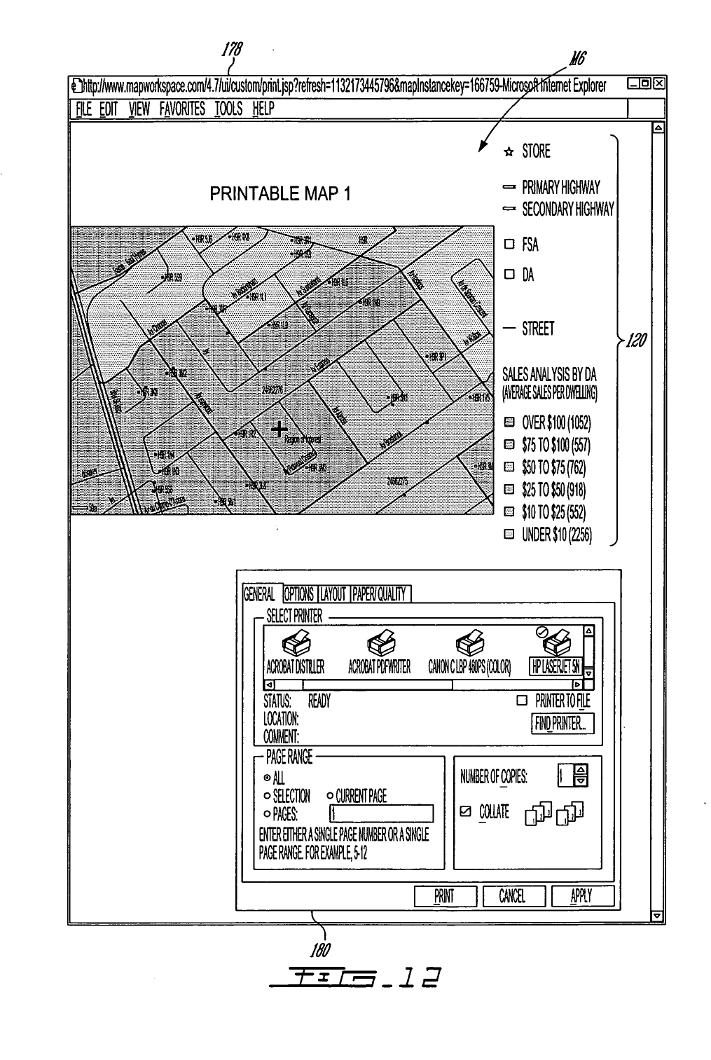

In this illustrative embodiment, the system 10 is operated by a distributor of hardcopy media, such as printed promotional circulars, flyers and the like, and used to provide Web mapping and QC services to one or more sponsors sponsoring a delivery of such hardcopy media. In particular, the system 10 is adapted to provide a registered user thereof (i.e. a given sponsor) access to mapped demographic, geographic and optionally proprietary user data of interest to the user's business or field of endeavor (as illustrated in FIGS. 3A, 3B and 8A-12) via an end terminal device 16 in communication with the system 10. Access to the mapped data may be provided to the sponsor in view of planning and coordinating a distribution of promotional circulars, flyers and other such hardcopy media to current and potential customers of the sponsor and/or of affiliates thereof.

In particular, the present system 10 provides a number of functions and options to optimize the hand distribution of advertising and various hardcopy media throughout a large geographical area using optimized carrier distribution routes targeting a selected audience. For instance, the system 10 may be used to combine and map demographic and proprietary customer data (e.g. point-of-sale (POS) data, credit card purchase information, preferred customer account information, rewards account information, etc.) provided by a sponsor and provide the sponsor access to this mapped data for the purpose of planning and organizing a targeted distribution of sponsor-specific hardcopy media. As such, an individual or company seeking to sponsor a distribution of hardcopy promotional materials to potential new and repeat customers may use the system 10 to plan and coordinate a targeted carrier distribution thereof through individual and/or cooperative media distribution and delivery strategies (flyers, circulars, add bags, flyer bundles, etc.).

In addition, when optional QC services are selected, the sponsor may also have access to QC data. Such QC data, discussed further hereinbelow, may comprise, for example, recorded geographic positions (e.g. GPS waypoints) of supervisory distribution spot-checks certifying the delivery of the relevant hardcopy media at various delivery locations along a distribution route and, the recorded geographic tracking (e.g. GPS tracking log) of the supervisor's visual inspection route taken between such spot-checks indicating segments of the distribution route visually monitored thereby between each recorded position. This QC data can be used for example, for providing a mapped visual QC of a given distribution project, tabulated QC data sheets identifying verified deliveries on various distribution routes in a given area or for a given project, consolidated and customizable QC reports for verifying a QC efficiency and completeness, and other such products and services available and of interest for both internal and external QC control practices.

Referring now to FIGS. 1 and 2A, the host system 12 is generally comprised of a communication bus or network 26 linking a number of system components comprising: a CPU or processor 28; input devices 30 such as a keyboard, mouse and the like; output devices 32 such as printers, display screens and the like; storage devices 34 such as hard drives and the like for storing data in various databases, data repertories and the like; and, an optional computer readable storage reader 36 and associated computer readable storage media 38 (CD-R, CD-RW, DVD-R, etc.) for uploading data into the host system 12 and storing data therefrom. The host system 12 is further comprised of a working memory 39 from which is run an operating system (OS) and graphical user interface program (GUI) 40, a Web mapping and QC application program(s) 42 for providing registered users access to the Web services through dedicated Websites stored and maintained by the host system 12, as well as a number of other programs 44 directly or indirectly relevant to the Web mapping and QC system 10 and services. As presented hereinabove, a Web server 20 and an associated external communication device and interface 22 are also included in the host system 12 to communicate with the end terminal devices 16 and operatively link the Web clients 24 thereof to the Web services provided by the system 10. Other communication devices and interfaces, as in 22, may also be included to locally or remotely communicate with the host system 12, namely to upload QC data thereto from a remote QC device 14.

Referring now to FIGS. 1 and 2B, the remote QC device 14 is generally comprised of a positioning device 45 for acquiring QC positions (e.g. GPS coordinates, cellular network triangulation coordinates, etc.) and a data recording medium 47 for recording QC data related thereto (coordinates, time, location, distribution info., etc.). In particular, the remote QC device 14 is illustratively comprised of a communication bus 46 linking a number of device components comprising: a CPU or processor 48; input and output devices 50 such as a keypad, scrolling and navigating devices, printers, display screens, removable storage devices and the like; storage devices 52 such as hard drives and the like for storing data in various databases, data repertories and the like; and, a GPS receiver 54 or other such positioning device for acquiring geographic positions during a QC process (presented further hereinbelow).

Still referring to FIGS. 1 and 2B, the QC device 14 is further comprised of a working memory from which is run an OS and GUI program 56 and other application programs useful in acquiring, storing and transferring QC data. A communication device and interface 58 is also provided to transfer QC data acquired and recorded in the device 14 to the host system 12. For example, QC data may be transferred between the QC device 14 and host system 12 through a direct communication link 59 or again via a wireless or landline communication network, as in 18. Alternatively, the QC data may be downloaded from the QC device 14 to an external computing device (not shown) and forwarded thereby to the host system 12 via e-mail, ftp or any other known or proprietary data transfer protocol.

As will be discussed further hereinbelow, the present embodiment considers the use of a GPS device as a suitable remote QC device 14 to provide the QC services and options presented herein. For instance, geographic positioning data may be coded using waypoint labels and the like to provide all necessary information for the implementation of the present QC system. A person of skill in the art will understand that other devices may be used to provide positioning information through various known methods without extending the scope of the present disclosure. Further, a GPS receiver may be linked directly to a number of data entry and storage terminals, such as a laptop or palmtop computer to provide further data entry and processing options. QC data may also be communicated directly to the host system 12 via various wireless communication means to skip any data uploading steps and provide faster integration of QC data into the host system 12.

A person of skill in the art will also understand that the above description of the Web mapping and QC system 10 and, particularly, of the technical architecture of the host system 12 and QC device 14, may be altered without departing from the general scope and nature of the present disclosure. Namely, although the host system 12 is illustrated as a single entity, a collection of system servers, processors, storage devices and the like may be communicatively linked in a local or regional network to provide the Web mapping and QC services to registered end users. Further, various landline and/or wireless communication networks may be encapsulated in communication network 18 to link the host system 12 and the end terminal devices 16.

Referring now to FIGS. 1 and 3B, the system 10, as briefly presented hereinabove, provides a user thereof access to mapped geographic, demographic and optionally proprietary data of interest to the user and the user's business. In FIG. 3B, such data is illustratively mapped (map M1) for a given geographical region within which the user wishes to augment business revenues generated from one or plural business locations or stores in the area, as in 60.

To target a specific audience through targeted distribution routes, the geographic area may be subdivided in a number of ways, for example either arbitrarily or using postal boundaries, census boundaries and the like. Note that the following exemplary mapping techniques and methods are based on regional and zonal boundaries established by Canada Post and Statistics Canada for postal and census purposes respectively. Similar postal, statistical and demographic boundaries established in other countries by various governmental and private agencies may also be used herein to provide similar results without extending the scope and nature of the present disclosure.

In particular, with reference to map M1 of FIG. 3A, census data may be provided for a number of Forward Sortation Areas (FSA) as in 62 generally corresponding to areas within which every dwelling is associated with the same first three digits of a Canadian postal code. For instance, map M1 illustrates FSAs wherein all postal codes begin with either H9H, H9G, H9R, etc. However useful for the mass mailing of hardcopy media, FSAs may not provide sufficiently targeted audiences for the targeted hand delivery of promotional materials. Namely, a given FSA may be comprised of between 5000 and 7000 households representing a variety of population demographics that may or may not all be of interest to a given sponsor wishing to sponsor a targeted distribution of hardcopy media.

However, census data is also provided for a number of Dissemination Areas (DA) as in 64, defined by Statistics Canada as the smallest census area within which demographic data is gathered and consolidated. These areas are generally comprised of 150 to 300 households and correspond well to an area covered by a carrier for the hand distribution of hardcopy media. However, these areas do not generally correspond to smaller postal code areas. Namely, full six-digit postal codes or local directory units (LDU) generally correspond to a single side of a street block and generally encompass 30 to 50 households in urban areas. These areas may be too small to form a full distribution route and may provide too narrow a scope for planning a distribution of promotional media. These small areas may also be targeted using regular mail distributions.

Consequently, it may be beneficial to map potential/repeat customer data and demographic data on these DAs as in 64 to plan and organize a targeted hand distribution or promotional materials. However, though demographic data is generally available for DAs as in 64, sponsor-specific data is often provided as a function of the mailing addresses, namely the postal codes, of the sponsor's customers. To combine and map this data onto the DAs of interest, while respecting public privacy laws, the present system 10 is adapted to map customer purchase information onto a DA as in 64 by processing the customer's postal code using a centroid approach. That is, every postal code or LDU is attributed a geographic position, identified by markers as in 65 in FIGS. 3A and 3B, based on a centroid or statistical center of every location or dwelling having this LDU. As such, every LDU can be geographically mapped within a single DA. Customer information associated with a specific LDU can then also be mapped within a respective DA as in 63 using this centroid approach. Since the LDU of the customer is used, an LDU shared by a number of dwellings, and not the customer's full address, personal privacy policies are respected.

Ultimately, using this centroid LDU-DA mapping method, the system 10 may provide a sponsor access to a mapping of an average amount of money spent per dwelling at one or plural retail locations 60, within each DA as in 64 of a given geographical region. This mapping may then allow the sponsor to plan and sponsor a targeted distribution of promotional media to residents of DAs within which higher average spending is reported. For instance, an average spending per dwelling is mapped in map M1 for various DAs as in 64 using various shadings or colors, the darker ones of which indicating higher potential customer ratings and thus suggesting that a targeted distribution of promotional material should be executed in these darker DAs.

Once the specific DAs as in 64 and distribution routes associated therewith are selected by the sponsor, distribution of sponsored media may take place to the targeted areas. If selected, QC data may also be recorded and access thereto provided to the sponsor.

A person of skill in the art will understand that although the above concentrates on an LDU-DA mapping method, other regional and/or zonal mapping methods may also be used. Further, other regional and/or zonal mapping boundaries and areas defined in Canada and/or in other countries may also be considered to delimit possible distribution routes and areas (e.g. US census blocks and block groups, Canadian census enumeration areas, zip code-specific areas, etc.).

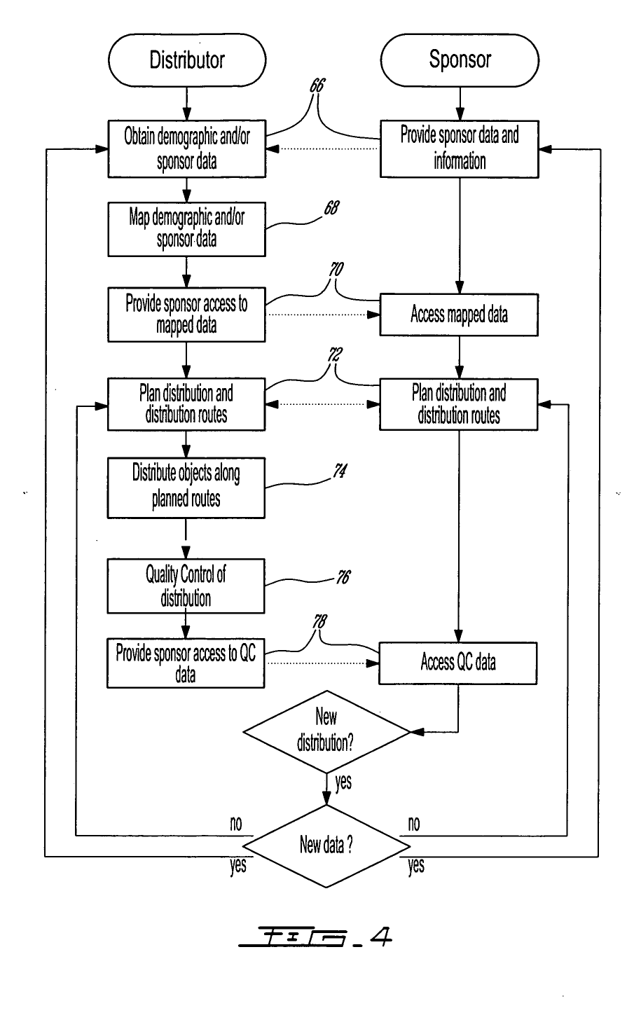

Referring now to FIGS. 2A, 2B and 4, a flow chart illustrating the various steps taken by the distributor and sponsor in preparing and executing a targeted distribution of hardcopy media is presented. In a first step 66, the sponsor provides the distributor data related to its customers, namely purchase histories including total spending, spending frequency, amounts spent per visit, etc. This data is illustratively provided in a database or tabular format associating respective spending histories with location information (e.g. LDUs) generally representative of a location of the customers' domiciles. Other data types, formats and contents may also be considered.

Still referring to FIGS. 2A, 2B and 4, in step 68, the distributor processes the provided data with the Web mapping application(s) 42 of system 10 to cluster and map the data, illustratively using the centroid approach presented hereinabove, onto the various DAs (reference 64 of FIG. 3B) within a geographical area of interest to the sponsor. In particular, a representative value of the data clustered for a given DA may be mapped by associating a representative semaphore thereto, a semaphore being defined herein as an entity for conveying information by means of a visual signal such as an icon, a color, a shading, a marker and the like, and placing the representative semaphore at a location of the given DA on the map of the area.

In step 70, the distributor provides the sponsor access to the mapped data via the host system 12. In step 72, the sponsor and distributor cooperatively plan, based on the mapped data and a target audience, a targeted distribution of hardcopy advertising material along distribution routes delimited by the DAs of interest. In step 74, the distributor proceeds in delivering the sponsored media according to plan. If selected, in step 76, the distributor also proceeds with a QC procedure of the distribution, described further hereinbelow, acquiring QC data therefor using QC device 14 and providing the sponsor access to this QC data in step 78, again via host system 12. The sponsor may then chose to proceed with subsequent distributions based on the same initial market analysis or provide updated data to the distributor to plan a new distribution strategy.

Referring now to FIGS. 2A, 2B, 4 and 5, the QC procedure, that is step 76 of FIG. 4, will be presented in greater detail. As presented above with reference to FIG. 4, once the targeted distribution has been planned by the sponsor and distributor in step 72, distribution of the sponsor-specific hardcopy media may begin (step 74). In order to implement the QC procedure and record QC data therefor in step 76, a supervisor travels along various segments of the planned distribution routes, either during or after the planned distribution, to perform a typically visual check for the distributed media along the route and perform occasional recorded spot-checks at various pre-selected or random delivery locations along the route. For instance, if the hardcopy media is delivered in the form of flyers and/or add-bags distributed on the doorsteps, door handles or residential mailboxes of the various houses on the planned distribution routes, then a supervisor may perform a visual check of distributed media by traveling by foot or by car along the route. To verify the delivered contents and certify the delivery of a sponsor's controlled media at various pre-selected and/or random delivery locations along the route, particularly when plural advertising materials are distributed together at a same time (add bundles, add-bags, flyer bundles, etc.), the supervisor may formally verify the delivered contents and record, when applicable, the verified presence of the controlled media at each location.

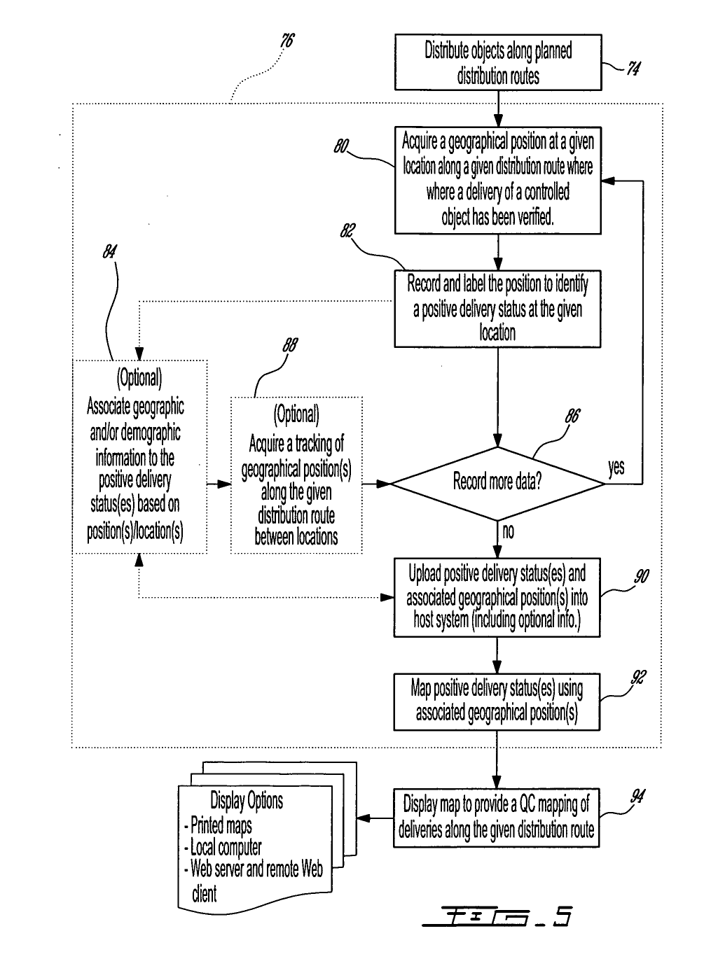

With particular reference to FIGS. 1 and 5, the supervisor, in step 76, travels along a given distribution route carrying the QC device 14, in this exemplary embodiment illustratively a GPS enabled device. At step 80, the supervisor stops at a selected delivery location along the route and, if a controlled object has been delivered at the location, acquires a geographic position (e.g. GPS position) for the selected location using the GPS receiver 54 of QC device 14 which is correlated with the controlled object either by default or through an appropriate code. At step 82, the supervisor records and labels the position in the QC device 14 to identify a positive delivery status of the controlled object at the selected location. Illustratively, the geographic position and positive delivery status of the selected location are recorded in the storage device 52 of the QC device 14 by storing a labeled waypoint therein, the label of which identifying the presence of the controlled object at the stored position and optionally (step 84), identifying other geographic, demographic and/or delivery information such as civic address, street name, supervisor code, etc. As such, the labeled waypoint can be later used to identify a delivery status, GPS position, GPS time and other such QC information for the selected location.

Note that in a particular embodiment, the nature or identification of the controlled objects is correlated with the labeled waypoints by default, that is only labeled waypoints related to a particular type of controlled objects is being collected. Alternatively, the labeled waypoints of different controlled objects could be collected and differentiated using a code or the like. In still another particular embodiment, the identification of the controlled object could be printed or otherwise be in a format (such as bar codes or RFID tags) scanable by a suitably equipped QC device 14.

For example, a waypoint label associated with a positive delivery status at a location having for address 216 Main street, may be coded as follows: 216SN. This label identifies the particular sponsor by an acronym for the name of its business (SN=Store Name) and identifies the civic address 216. The GPS position and GPS time are also automatically associated with the stored waypoint in the QC device's storage device 52. As such, when the waypoint is ultimately mapped (discussed further hereinbelow), the sponsor may access the position, time and address of the waypoint. In addition, since street names are generally present on the map, the full address of the delivery is known from the waypoint information without needing to include the street name in the waypoint label.

A person of skill in the art will understand that other waypoint label coding may be used without departing from the general scope and nature of the present disclosure. For instance, if the delivery of plural objects are being controlled in a single QC step, a code identifying the presence of all controlled objects may be entered instead of using individual store and/or sponsor codes. Alternatively, a waypoint may be generated for each controlled object. Other coding methods may also be used to include a number of additional information related to the controlled location, as illustrated in step 84. As presented hereinabove, other options for storing location and positioning information may also be considered using alternative QC devices and device combinations (GPS/laptop, GPS/palmtop, etc.). Hand written and/or electronic notes stored in a separate data recording medium (notepad, laptop, palmtop, etc.) may also be recorded at the locations and later entered into the host system 12 to be associated with the recorded QC data.

Once the waypoint is stored with an appropriately coded label, the supervisor may proceed, in step 86, to acquire more data points at other delivery locations along the route or along other distribution routes in the area, thus returning to step 80.

Optionally, the supervisor may acquire a tracking or GPS track log, at step 88, between each controlled location. In practice, as stated hereinabove, the supervisor may visually verify the presence of delivered objects by traveling by foot, by car or by any other transportation means, along the controlled distribution routes. This option thus provides a positional tracking of the supervisor's visual QC path along various controlled segments of the controlled distribution routes that may ultimately be mapped to illustrate a visual QC of distributed objects along these segments. As such, by certifying through recorded waypoints the presence of delivered objects at selected locations along a given route and by providing a recorded QC path between these locations on which a visual QC procedure was implemented, a valuable QC evaluation of the planned distribution is obtained.

In step 90, when all data waypoints and optional tracking logs are acquired for a given QC outing, the supervisor may upload the acquired QC data into the host system 12. As stated hereinabove with reference to FIG. 1, the data may be uploaded from the QC device 14 via its communication device and interface 58 when linked either to a dedicated and/or public communication network, as in 18, or again via a direct communication link 59. For example, QC data could be uploaded to the host system's storage device(s) 34 via landline and/or wireless e-mail, Internet uploads, ftp or other such data transfer protocols available through network 18. Alternatively, data may be directly uploaded using a direct link 59 that may include, but is not limited to, a USB link, a serial link, a wireless IR link, and other such direct communication links. Uploads using intermediary communication devices may also be considered.

Once the data has been uploaded to the host system's storage device(s) 34, it may be processed and mapped, in step 92, by the host's CPU(s) 28 and Web mapping and QC application(s) 42 combining the QC information stored in the waypoint labels with their respective GPS position, time, etc. Additional information stored in the host's storage device(s) 34 may also be associated with each location at this point if such information is available. This information may include route information, demographic and/or geographic information related to the DA and/or FSA within which the waypoint was taken, customer information extracted from sponsor-specific customer information databases and associated with the civic address stored in the waypoint label such as LDU purchase history, statistics and the like, and other such information.

In addition, the Web mapping and QC application(s) 42 may also be used to extrapolate a respective geographical region (e.g. DA, FSA, etc.) within which each QC was recorded. As such, QC reports identifying within which region hardcopy media distributions have been verified can be generated automatically. For instance, the geographic coordinates of a given QC waypoint may be associated automatically with a given DA encompassing these coordinates. Since each DA illustratively corresponds in the present embodiment to a single distribution route, a report may be generated identifying which DA, and thereby which distribution route, has be controlled by the distributor. Accordingly, a report may also be generated identifying a fraction of distribution routes verified for a given area, namely a given FSA. For example, if QC waypoints have been recorded on 72% of all distribution routes within a given FSA, a report identifying this result may be automatically generated from the QC data stored on the host system 12. These and other such reports may be generated weekly, monthly, quarterly or annually to provide both an internal and external QC assessment of a given distribution project. These reports may also be customized based on a number of QC parameters set to qualify and quantify QC requirements and reporting procedures (e.g. number of required QC waypoints for a given route, number of QC waypoints per dwelling in a given zone, frequency of QC checks for a given project, etc.). Furthermore, since the data used in generating these reports was acquired directly from a remote QC device, as in 14, such as a GPS device, the present QC procedure and reporting system benefits from enhanced automation and transparency.

A person of skill in the art will understand that other such logical data links and associations, usable for instance in generating various alternative QC mapping and reporting products and services, may be processed and established by the host's CPU(s) 28 by implementing instructions stored and maintained by the Web mapping and QC application(s) 42 and other related database management and processing algorithms stored in the host system 12.

In step 94, the mapped data is displayed, again using the host's CPU(s) 28 and Web mapping and QC application(s) 42, on printed and/or screen maps generated with the host's output device(s) 32, and/or on printed and/or screen maps generated by a client 24, and an associated client output device, having access to the data via the host's Web server 20. The raw data and various reports generated therefrom may also be displayed via a local or remote display/printer.

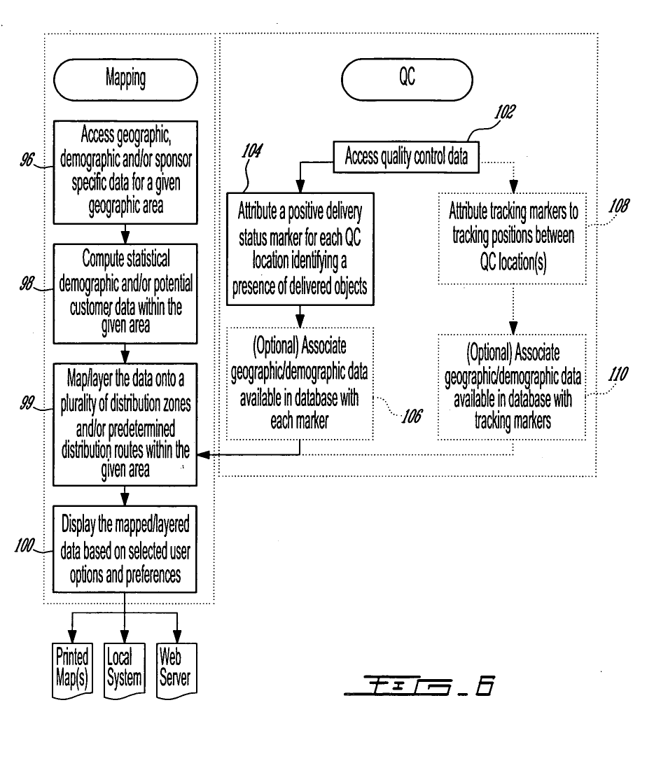

Referring now to FIGS. 2A and 6, the Web mapping and QC application(s) 42 will now be described in greater detail. Generally, the application(s) 42 is adapted to communicate with various databases and/or data repertories maintained on the host's storage device(s) 34 to access, cluster and/or format various data entries therein for the purpose of mapping and displaying the data and, ultimately make the formatted data accessible to the sponsor of a given distribution project. In particular, the application(s) 42 processes, clusters, interlinks and maps a number of demographic and/or sponsor-specific data using various data aggregation and clustering methods (data centroids, weighted averaging, etc.) and various geo-mapping techniques, often commonly referred to using the umbrella term geomatics, in order to display this data and optionally provide interactive Web maps linking mapped objects and markers with further tabulated geographic, demographic and/or sponsor specific data stored and maintained by the host system 12.

In a first step 96, the application(s) 42 accesses geographic, demographic and/or sponsor-specific data for a given geographic area from the host's storage device(s) 34. Based on a number of selected mapping and/or clustering parameters selected by the sponsor and/or distributor, such parameters including, but not limited to, data aggregation parameters (DA, FSA, LDU, area codes, etc.), statistical data analysis techniques (centroid, weighted averaging, etc.), data types (customer purchase history, census demographics, etc.), and the like, the application(s) 42 provides instructions, in step 98, to be implemented by the CPU(s) 28 to compute statistical data for each selected area. For instance, this may include computing average customer spending at a given commercial location per dwelling within a given DA, FSA, etc, tabulating average demographics for selected areas, and other such clustered information of potential interest to the sponsor.

Once the data has been clustered for the selected areas, the clustered data is mapped using a number of representative semaphores, in step 99, and operatively linked to the selected areas and/or distribution zones/routes. In practice this may be implemented by generating a logical link or pointer between the clustered data and representative semaphore associated with a given distribution area (DA, FSA, etc.) and geographic positions associated with this same area, all of which being stored on the host's storage device(s) 34, such that a mapping of the clustered data is layered onto the given distribution area using the geographic positions associated therewith via the representative semaphores. Other data mapping, layering and/or aggregation techniques should be apparent to a person of skill in the art.

In step 100, the mapped data is displayed, in accordance with a number of user options and preferences, using local printers and displays and/or remote client printers and displays having access to the data via the Web server 20.

When QC services are selected, the application(s) 42 also provides a number of QC instructions to be implemented by the CPU(s) 28 in order to process and display the acquired QC data discussed hereinabove with reference to FIGS. 4 and 5. In step 102, the QC data (waypoints, tracking logs, etc.) is accessed from the host's storage device(s) 34 for processing. In step 104, a positive delivery status marker is attributed to each QC location identified by a stored waypoint. Depending on the format of the waypoint's label, QC information such as civic address, customer info, and the like, is also associated with the attributed marker, in step 106, again using an operative link and/or pointer generated by the CPU(s) 28.

If tracking logs are available, the application(s) 42 will also instruct the CPU(s) 28, in step 108, to attribute positive tracking markers to each tracking position identified by the tracking logs. If available, geographic and/or demographic information associated with these tracking positions may also be linked to the attributed tracking markers via a logical link or pointer, in step 110.

Both the waypoint markers and the tracking markers may then be mapped/layered in step 99 and displayed in step 100, providing logical links/pointers to QC information associated therewith.

In addition, as presented hereinabove, a number of QC reports and data sheets may also be generated and displayed via a local and/or remote display/printer. Logical data links between the QC data and related distribution zone information may be established and maintained by the application(s) 42 and used to generate various QC reports and track sheets to evaluate and assess the efficiency, quality and completeness of established quality control procedures.

A person of skill in the art will understand that a number of methods and algorithms may be used by the application(s) 42 to cluster, map, link, aggregate and display the above geographic, demographic, sponsor-specific and/or QC data. Also, various techniques may be used to provide access to this mapped and aggregated data to the sponsor of a given distribution project. In the present embodiment, the data is accessed and displayed by a Web client 24 via the host's Web server 20. The following discussion thus provides, with reference to FIGS. 3A, 3B and 7-12, examples of an illustrative Web site maintained on the Web server 20 by the host system 12 and providing a registered sponsor access to this data.

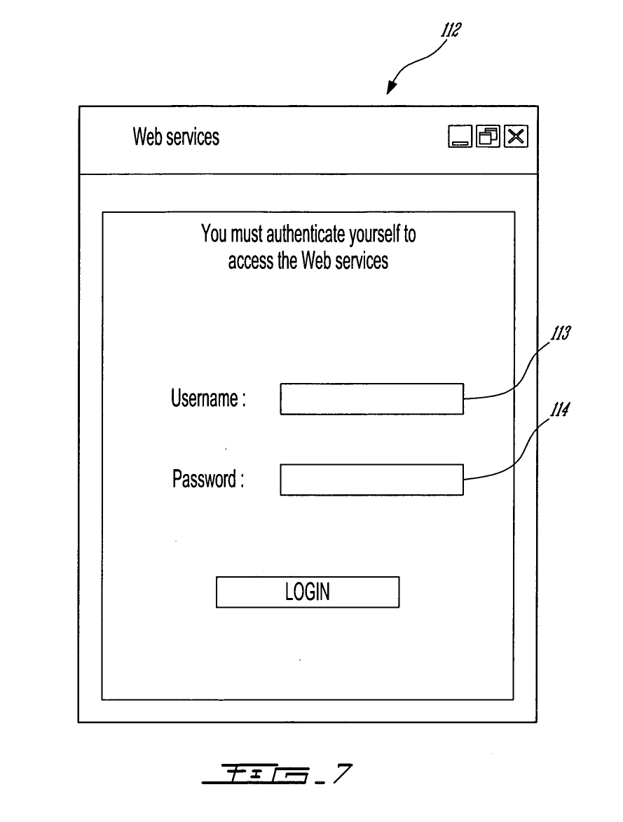

Referring now to FIGS. 1 and 7, the Web services provided by the distributor via a Web site hosted by the Web server 20 may be accessed by a registered sponsor using a Web client 24 in communication with the server 20 over the communication network 18. To access the Web site, a login page 112 (FIG. 7) is first accessed, for instance using a standard Web browser, requesting the input of the sponsor's username 113 and password 114. Upon successful verification of the sponsor's username and password, the sponsor is given access to the distributor's Web services. Other login procedures and/or user identification and verification algorithms may also be considered and should be apparent to a person of skill in the art.

Referring now to FIGS. 3A and 3B, once the sponsor is logged onto the distributor's Website, the sponsor is presented with a number of mapping options. In this exemplary screen display, the Web site provides a number of interactive windows including a map window 116 displaying a selected map M1, a legend window 118 displaying a legend 120 associated with the map M1, an information window 122 selectively displaying various information associated with interactive objects displayed on the map M1 and, a layer control window 124 through which the sponsor may select what type of information he wishes to view layered onto the map M1.

In the particular screen display of FIGS. 3A and 3B, the map M1 comprises a regional mapping of potential customer data provided by the sponsor from their current customer lists and clustered by the system 10. In map M1, average sales per dwelling for each DA 64 in the region of a given store 60 is mapped using the centroid LDU-DA mapping approach described hereinabove. Consequently, DAs displayed with darker tones represent DAs wherein high current customer sales have been recorded. DAs displayed with lighter tones represent DAs wherein low current customer sales have been recorded. Basic mapping features displayed in map M1 include street lines 126, store location(s) 60, FSA boundary lines 130 and identification 132 (H9R, H9H, etc.), DA boundary lines 134 and other such geographic/demographic details.

The map window 116 is generally comprised of the map M1 and a number of interactive icons for selecting various viewing and interactive information features of the Website. Exemplary icons may include:
zoom-in and zoom-out buttons 138 and 140 to respectively allow the user to zoom in and out by clicking or by dragging a selection area on the map M1;
a pan button 142 to allow the user to click and drag the map M1 to pan to another area;
a search button 144 to allow the user to search for various information interactively linked with the map M1 and stored in the host system's storage device(s) 34 (FIG. 2A);
a ruler button 146 to allow the user to interactively measure distances on the map M1 using a click and drag motion;
a legend button 148 to allow the user to selectively display the legend window 118;
E-mail and print buttons 150 and 152 to respectively allow the user to send the map M1 (or modified versions thereof) to a recipient e-mail client or to a local printer communicatively linked to the end terminal device 16 (FIG. 1);
an information button 153 to selectively open the information window 122 and make information requests within the map M1;
a layer control button 154 to allow the user to selectively display the layer control window 124; and
an annotate button 156 to allow the user to make annotations on the map M1.

In the exemplary screen display of FIGS. 3A and 3B, the layer control window 124, the information window 122 and the legend window 118 have all been selected. In the layer control window 124, a Customer Location option 158 has been selected such that the geographic location of customers, in this embodiment consisting of centralized geographic LDU position markers 65, are also provided as a display layer of map M1.

Still referring to FIGS. 3A and 3B, to select information for display in the information window 122, the user first selects the information button 153 and then interactively clicks on the map M1 an interactive object or region about which information is desired. For instance, in the exemplary screen display of FIG. 2, the user has clicked the map M1 within the area defining the DA 24662276 within FSA H9R. As such, Web server 20 accesses demographic and/or clustered data associated with this DA (161) and FSA (163) stored in the storage device(s) 34 of the host system 12 and, using the Web mapping and QC application(s) 42, displays this information in the information window 122. As a result, the sponsor gains access to specific data related to selected areas of interest.

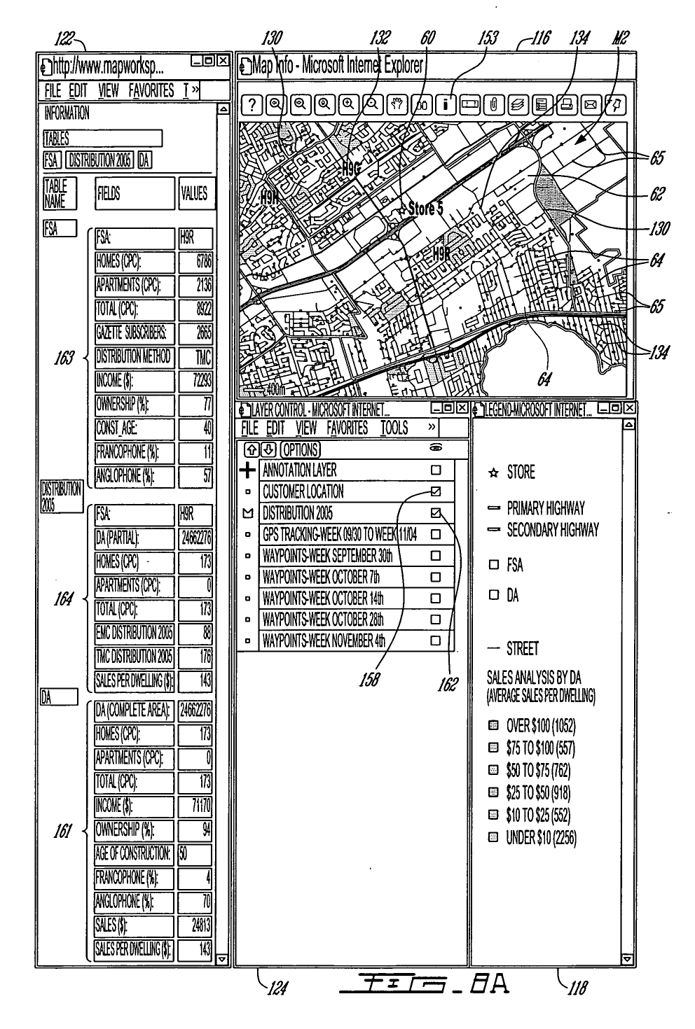

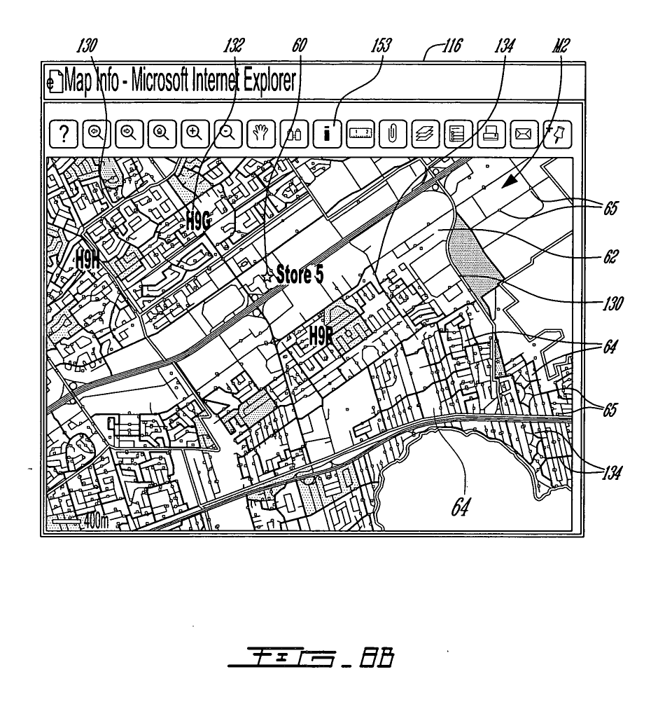

Referring now to FIGS. 8A and 8B, a further exemplary screen display of a map M2 generated by the distributor's Website is presented. In this screen display, a Distribution 2005 option 162 has been selected in the layer control window 124. This options allows a sponsor to view, for example, a current or suggested targeted distribution area based on the mapped potential customer data of FIG. 2. In other words, areas (i.e. DAs) within which high customer sales were reported could be targeted in a current or future distribution of hardcopy advertising media. This allows the sponsor to view the general area covered by his sponsored hardcopy media distribution and/or plan for future distributions.

In particular, the map M2 displays DAs selected or proposed for a targeted distribution in a particular tone to be differentiated from DAs not selected for the targeted distribution. By selecting the information button 153 and clicking within one of the selected or proposed distribution areas, the sponsor may access, through information window 122, distribution information 164 pertaining to a planned or proposed distribution strategy for this area.

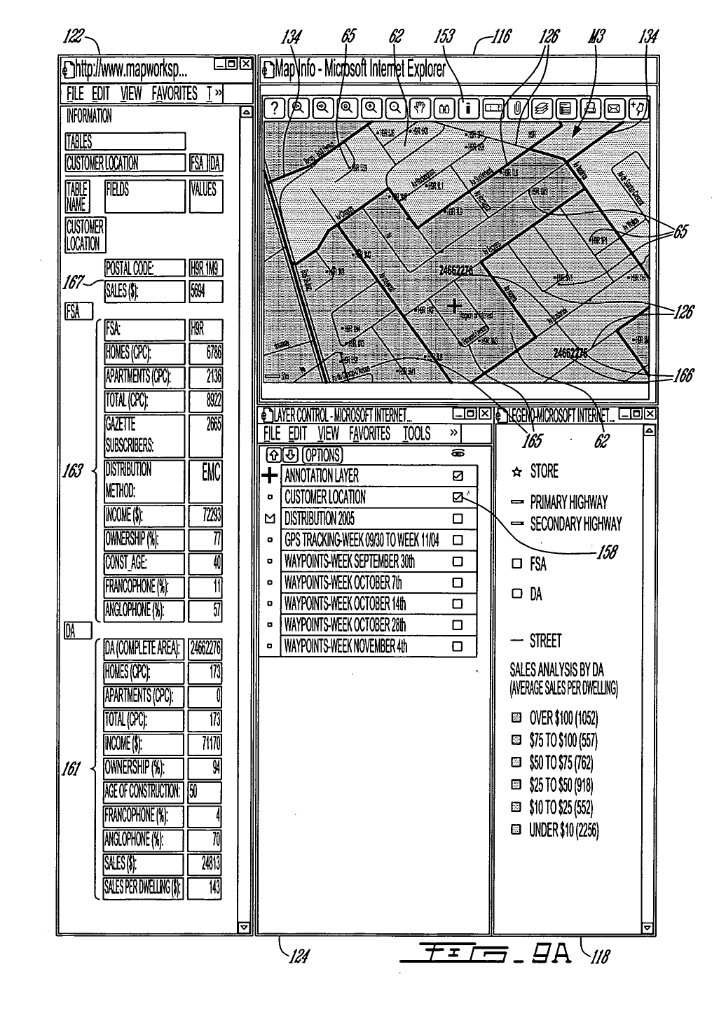

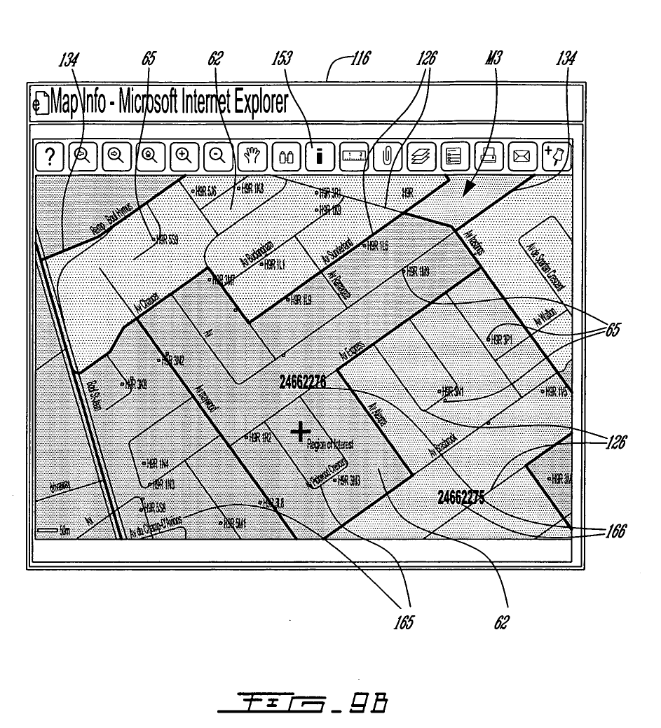

Referring now to FIGS. 9A and 9B, a still further exemplary screen display of a map M3 generated by the distributor's Website is presented. In this screen display, the sponsor has zoomed in to a smaller area of the map M1 of FIG. 2 thereby displaying in the map M3 of map window 116, a zoomed-in zone mapping of the potential customer data. In this zonal map M3, street names 165 and DA numbers 166 (generally associated with specific targeted distribution route numbers) are now displayed. In the information window 122, the user has selected to view LDU information 167 associated with the specific LDU H9R 1M9 by clicking directly on the LDU location 65 associated therewith. This provides the sponsor access to greater map details and information.

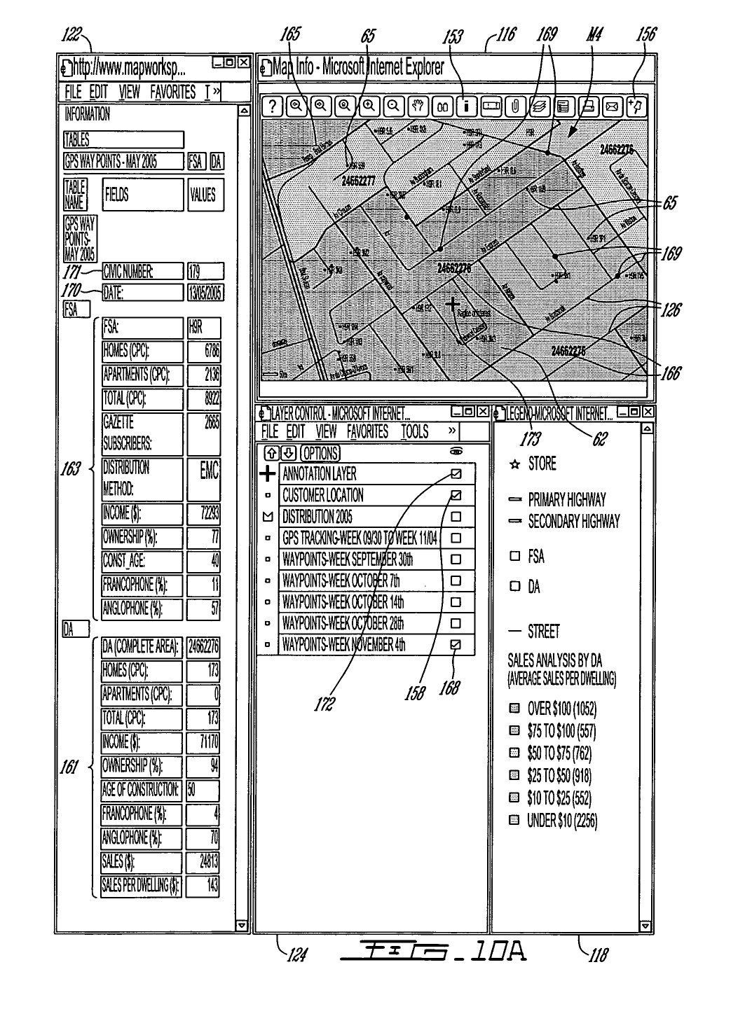

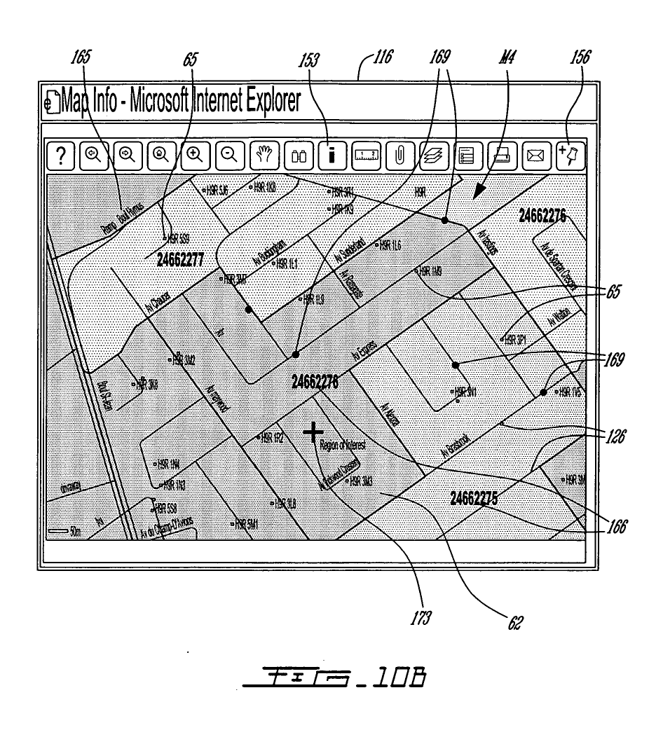

Referring now to FIGS. 10A and 10B, an exemplary screen display of a map M4 generated by the distributor's Website is now provided illustrating the optional use and display of QC data related to current distribution projects. In this screen display, the GPS Waypoints—Week of November 4 option 168 has been selected such that QC waypoints recorded by a supervisor of the current distribution project during the week of November 4ₜₕ are displayed by interactive waypoint location markers 169 on a QC layer of map M4. This allows the sponsor to view the actual locations of supervisory spot-checks completed by the supervisor to certify the delivery of sponsored objects at these locations. By selecting the information button 153 and clicking one of the interactive location markers 169, the sponsor obtains, in information window 122, the date 170 the waypoint was recorded and the civic address 171 at which it was taken. Since the street names 165 are already provided on the map M4, the sponsor has the full civic address associated with the selected waypoint 169. FSA information 163 and DA information 161 are also provided.

Still referring to FIGS. 10A and 10B, in addition an Annotation option 172 is also selected herein to include on the map M4 an annotation marker 173 identifying a region of interest to the sponsor. Annotation markers may be added and the labels thereof modified by clicking the annotation button 156, selecting a location on the map M4 and entering, in an annotation dialog box generated by the Website (not shown), label details to be associated with a new or existing marker.

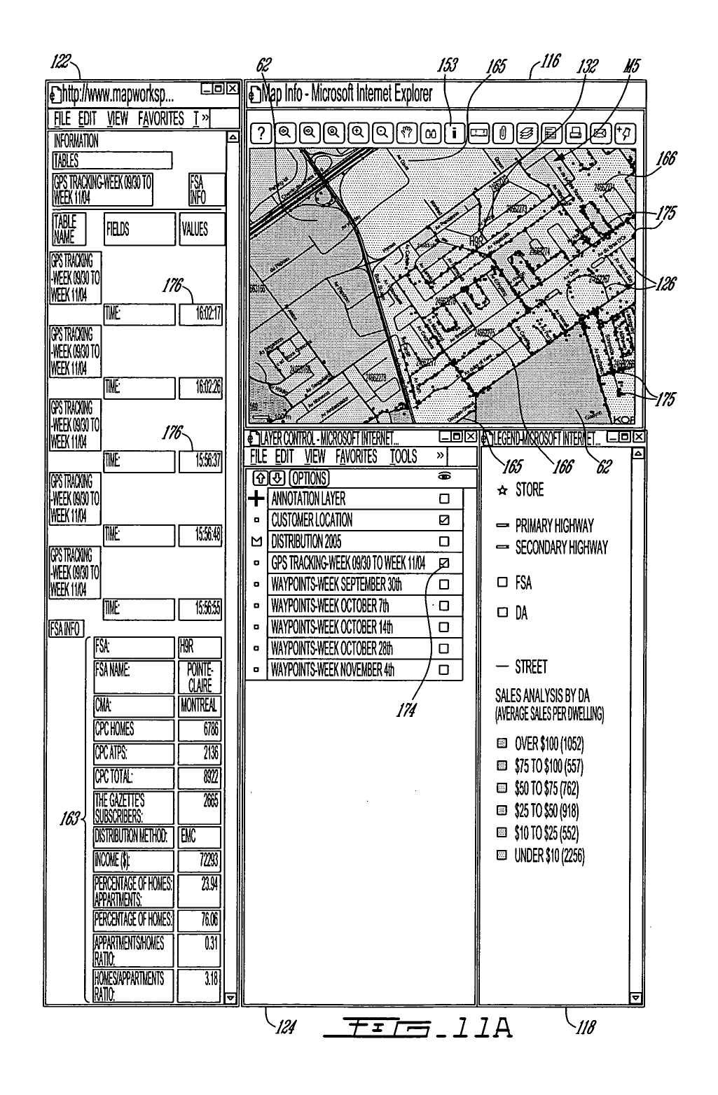

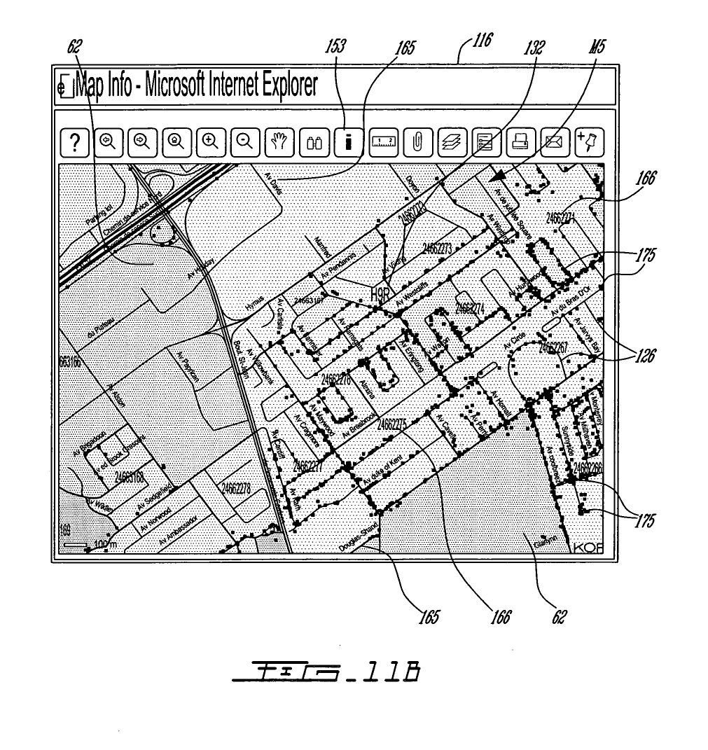

Referring now to FIGS. 11A and 11B, an exemplary screen display of a map M5 generated by the distributor's Website is now provided illustrating the optional use and display of QC tracking data related to current distribution projects. In this screen display, the GPS Tracking option 174 is selected such that a tracking of the supervisor's path during QC checks are displayed by interactive tracking markers 175 on an alternative QC layer of map M5. This allows the sponsor to view the actual path followed by the supervisor between supervisory spot-checks during which a visual inspection of the distribution route was completed. By selecting the information button 153 and clicking one or plural interactive tracking markers 174, the sponsor obtains, in information window 122, the GPS time 176 recorded by the GPS tracking log.

Using both the GPS waypoint and GPS tracking options illustrated in FIGS. 10A and 11A respectively, the sponsor obtains QC supervision over the sponsored distribution project and knows when and where the sponsored hardcopy media was delivered. As discussed hereinabove, other QC data may be recorded, stored and linked to the waypoint markers 169 and tracking markers 175 and made accessible to the sponsor via the distributor's interactive Website. Also, access to QC reports and data sheets, as presented above, may also be provided via the distributor's Web site. These reports may provide the sponsor with aggregated and/or summarized QC data useful in evaluating an effectiveness and completeness of established QC procedures. Other such products and services may also be considered in the present context without departing from the general scope and nature of the present disclosure.

Referring now to FIGS. 1, 10A and 12, an exemplary screen display is provided illustrating a printable map M6 generated by the distributor's Website from the map M4 of FIG. 10A. In general, the sponsor may select the print button 123, as illustrated in FIG. 10A, to print a displayed map. Automatically, the legend 120 and selected map (in this case map M4) are provided in a printable map window 178 and a print dialog box 180, generated by the Web client 24, is opened allowing the sponsor to send the printable map to a local printer in communication with the end terminal device 16.

A person of skill in the art will understand that various other options and screen displays may be available to provide additional mapping and data services to the sponsor without extending the general scope and nature of the present disclosure. In general, the above system 10 and Web services provided thereby allow a sponsor to visualize and plan a targeted distribution of hardcopy media using a remote Web client 24. Furthermore, since the system 10 is adapted to cluster and map demographic and/or sponsor-specific data onto geographic areas generally sized to adequately delimit individual hand distribution routes, even when such data is not previously categorized using such areas, the mapped data is well suited for the fine targeting of hardcopy media distributions and for planning such distributions using various targeted carrier distribution routes.

Also, the system 10 allows the sponsor to obtain QC data, again optionally via Web client 24, such that the sponsor may supervise the sponsored distribution project. Mapped location and tracking markers provide solid proof to the sponsor that the sponsored media has been delivered and indicates when and specifically where the deliveries took place. This QC data also allows for a thorough internal QC of distribution projects that is transparently made available for inspection by the sponsor of such projects.

Although the invention has been described with reference to certain specific embodiments, various modifications thereof will be apparent to those skilled in the art without departing from the spirit and scope of the invention as outlined in the claims appended hereto.

What is claimed is:

1. A method for providing a mapped quality control of objects delivered at locations along a distribution route, the method comprising the steps of:
acquiring a QC position of at least one object delivery location using a portable positioning device;
assigning a positive delivery status marker to said QC position; and
displaying said marker on a map of an area encompassing the distribution route.

2. The method of claim 1, the method further comprising repeating said steps for plural object delivery locations.

3. The method of claim 1, wherein said acquiring step is executed via a computerized data entry terminal communicatively linked to said positioning device.

4. The method of claim 3, the method further comprising the step after said acquiring step of storing said QC position via said terminal.

5. The method of claim 3, wherein said portable positioning device and said terminal are operatively incorporated into a GPS device, said acquiring step comprising acquiring said QC position via said GPS device.

6. The method of claim 5, the method further comprising the step after said acquiring step of storing said QC position in said GPS device via a waypoint stored therein.

7. The method of claim 6, wherein said waypoint comprises a label stored therewith, said label identifying information related to said location, the method further comprising the step of providing access to said information via said map.

8. The method of claim 7, wherein said label identifies at least one of a delivery status at said location, an object delivered at said location, geographic data associated with said location, a civic address at said location, demographic data associated with said location and, GPS data associated with said QC position.

9. The method of claim 1, the method for providing a mapped quality control of objects delivered along plural distribution routes, said displaying step comprising displaying said marker on a map of an area encompassing the distribution routes.

10. The method of claim 1, the method further comprising the steps of
storing said QC position in a computer storage device accessible to a Web server; and
providing a Web client access to said QC position via said Web server;
wherein said displaying step comprises displaying said map via said Web client.

11. The method of claim 1, wherein the objects are selected from a group consisting of circulars, flyers, advertisements and hardcopy marketing media.

12. The method of claim 1, the method for providing the mapped quality control of delivered objects to a sponsor sponsoring the delivery, wherein the objects are delivered to targeted consumers as a means for advertising to said consumers, the mapped quality control providing the sponsor a visual assessment of a number of said consumers having access to the objects.

13. The method of claim 1, the method further comprising the steps of:
acquiring a plurality of tracking positions along the distribution route in a vicinity of said location;
assigning a tracking marker to at least one of said tracking positions; and
displaying said tracking marker on said map.

14. The method of claim 13, wherein said portable positioning device comprises a GPS device, said tracking positions being acquired via said GPS device and stored in a tracking log thereof.

15. A system for use in providing a mapped quality control of objects delivered at locations along a distribution route, the system comprising:
a portable positioning device for acquiring a QC position of at least one object delivery location;
a data processor, having communicative access to said QC position, adapted to assign a positive delivery status marker thereto; and
an output device for displaying said marker on a map of an area encompassing the distribution route.

16. The system of claim 15, the system further comprising a data entry terminal communicatively linked to said portable positioning, said QC position being acquired via said data entry terminal.

17. The system of claim 16, wherein said data entry terminal and said positioning device are operatively incorporated into a GPS device, said QC position being acquired via said GPS device.

18. The system of claim 17, wherein said QC position is acquired via a GPS waypoint stored on said GPS device.

19. The system of claim 18, wherein said GPS waypoint comprises a label stored therewith identifying information related to said location and wherein said processor, having communicative access to said information, is adapted to associate said information with said marker to provide access thereto via said map.

20. The system of claim 19, wherein said label identifies at least one of a delivery status at said location, an object delivered at said location, geographic data associated with said location, a civic address at said location, demographic data associated with said location, and GPS data associated with said QC position.

21. The system of claim 15, the system further comprising a host system comprising said processor, said host system comprising at least one media storage device communicatively accessible to said processor, said QC position being uploaded to said media storage device from said positioning device via a communication link established therebetween.

22. The system of claim 21, the system further comprising a Web server having communicative access to said media storage device, wherein said map may be displayed via a Web client in communication with said server on a remote output device operatively linked to said client.

23. The system of claim 22, wherein said map may be printed via said client.

24. The system of claim 15, wherein the objects are selected from a group consisting of circulars, flyers, advertisements and hardcopy marketing media.

25. The system of claim 15, said portable positioning device further being used for acquiring a plurality of tracking positions along the distribution route in a vicinity of said location, said processor having access to said tracking positions being adapted to assign a tracking marker to at least one of said tracking positions and, said output device being adapted to display said tracking marker on said map.

26. The system of claim 25, wherein said portable positioning device comprises a GPS device, said tracking positions being acquired via said GPS device and stored in a tracking log thereof.

27. A computer-readable storage medium having a computer-readable program embodied therein for directing operations of a computer system comprising a processor, a storage device and an output device, wherein the computer-readable program comprises instructions for operating the computer system to provide a mapped quality control of objects delivered at locations along a distribution route in accordance with the following:
maintaining at least one database on said storage device, said database comprising at least one QC entry comprising a QC position, each QC entry indicating a delivery of at least one of the objects at a location represented by said QC position;
assigning a positive delivery status marker to each QC entry using the processor; and
displaying each of said markers on a map of an area encompassing the distribution route via the output device.

28. The computer-readable storage medium of claim 27, said QC entry further comprising information related to said location, the program further comprising instructions for assigning a logical link between said marker and said information for use as a pointer to said information in said database such that access thereto may be provided via said marker on said map.

29. The computer-readable storage medium of claim 28, wherein said output device comprises an interactive display and said marker comprises an interactive marker displayed thereon, said information being accessed and displayed via said interactive marker.

31. The computer-readable storage medium of claim 28, wherein said information comprises at least one of a delivery status at said location, an object delivered at said location, geographic data associated with said location, a civic address associated with said location, demographic data associated with said location, and GPS data associated with said QC position.

32. The computer-readable storage medium of claim 27, the computer system further comprising a Web server, the program further comprising instructions for displaying said map via a Web client communicatively linked with said server on a remote output device operatively linked thereto.

33. The computer-readable storage medium of claim 27, wherein said output device comprises at least one of a display screen and a printer.

34. The computer-readable storage medium of claim 27, the database further comprising a plurality of tracking entries each comprising a tracking position representative of an area in a vicinity of said location, the program further comprising instructions for assigning a tracking marker to at least one of said tracking entries using the processor and displaying said tracking marker on said map via the output device.

35. The computer-readable storage medium of claim 34, said tracking entries further comprising tracking information related to said tracking positions, the program further comprising instructions for assigning a logical link between said tracking marker and said tracking information for use as a pointer to said tracking information in the database such that access to said tracking information may be provided via said tracking marker on said map.

36. A computer-readable storage medium having a computer-readable program embodied therein for directing operations of a Web based computer system comprising at least one processor, a storage device, a Web server and a Web client communicatively linked to the server, wherein the computer-readable program comprises instructions for operating the system to provide a mapping of location-specific market data for an area in view of targeting a delivery of hardcopy media via a carrier in the area in accordance with the following:
maintaining at least one database on said storage device, said database comprising a first series of data entries and a second series of data entries, each of said first series of entries comprising market data having a value and a location and each of said second series of entries comprising a distribution zone, said distribution zone being sized to encompass a respective carrier distribution route for the delivery;
mapping said first series of entries and said second series of entries on a map of the area, wherein said mapping of each of said first series of entries comprises generating a semaphore representative of said entry value and placing said semaphore on said map at said entry location;
providing the client access to said map via the server to be displayed thereby via a client output device.

37. The computer-readable medium of claim 36, wherein each of said second series of entries comprises zone information, the computer program further comprising instructions for assigning a logical link between said mapping of each said second series of entries and said zone information for use as a pointer to said zone information in said database such that access thereto may be provided via said map.

38. The computer-readable medium of claim 36, wherein said client output device comprises at least one of a display screen and a printer.

39. The computer-readable medium of claim 36, wherein each distribution zone corresponds to at least one of a Canadian census dissemination area, a Canadian census enumeration area, an American census block and an American census block group.

40. The computer-readable medium of claim 36, wherein said value of each of said first series of data entries comprises statistically clustered market data representative of a population in a specific area and said position of each of said first series of data en comprises a representative position of said specific area.

41. The computer-readable medium of claim 40, wherein said specific area comprises at least one of a postal code area, an area code area, a forward sortation area, a local directory unit area, a dissemination area, an enumeration area, a census block, a census block group, a community, a residential block and a municipality.

42. The computer-readable medium of claim 40, wherein said statistically clustered market data comprises at least one of an average spending per dwelling in said specific area, an average age of said population in said specific area, a number of homes in said specific area, an average income in said specific area, an average age of homes in said specific area.

43. The computer-readable medium of claim 40, wherein each specific area corresponds to one distribution zone such that only one semaphore is mapped for each distribution zone on said map.

44. The computer-readable medium of claim 40, wherein said statistically clustered market data is clustered using a centroid approach.

45. The computer-readable storage medium of claim 36, wherein each of said first series of data entries comprises location information related to said location, the program further comprising instructions for assigning a logical link between said semaphore and said location information for use as a pointer to said location information in said database such that access thereto may be provided via said semaphore on said map.

46. The computer-readable storage medium of claim 45, wherein said client output device comprises an interactive display and said semaphore comprises an interactive semaphore displayed thereon, said location information being accessed and displayed via said interactive semaphore.

47. The computer-readable storage medium of claim 36, wherein said database further comprises at least one QC entry comprising a QC position, each QC entry indicating a delivery of at least one of the hardcopy media at a given delivery location represented by said QC position, the program further comprising instructions for assigning a positive delivery status marker to each said QC entry using the processor and displaying each of said markers on said map.

48. The computer-readable storage medium of claim 47, said QC entry further comprising QC information related to said given delivery location, the program further comprising instructions for assigning a logical link between said marker and said QC information for use as a pointer to said QC information in said database such that access thereto may be provided via said marker on said map.

49. The computer-readable storage medium of claim 47, the database further comprising a plurality of tracking entries each comprising a tracking position representative of an area in a vicinity of said location, the program further comprising instructions for assigning a tracking marker to at least one of said tracking entries using the processor and displaying said tracking marker on said map.

50. The computer-readable storage medium of claim 36, wherein the client is provided access to said map via an interactive Website maintained by the server.

51. A Web based system for displaying location-specific market data for an area in view of targeting a delivery of hardcopy media via a carrier in the area, the system comprising:
at least one database, said database comprising a first series of data entries and a second series of data entries, each of said first series of entries comprising market data having a value and a location and each of said second series of entries comprising a distribution zone, said distribution zone being sized to encompass a respective carrier distribution route for the delivery;
a data processor for mapping said first series of entries and said second series of data entries on a map of the area, wherein said mapping of each of said first series of data entries comprises generating a semaphore representative of said entry value and placing said semaphore on said map at said entry location;
a Web server for providing access to said map; and
a Web client, communicatively linked to said server, for displaying said map via a client output device.

52. The system of claim 51, wherein said client output device comprises at least one of a display screen and a printer.

53. The system of claim 51, wherein each distribution zone corresponds to at least one of a Canadian census dissemination area, a Canadian census enumeration area, an American census block and an American census block group.

54. The system of claim 51, wherein said value of each of said first series of data entries comprises statistically clustered market data representative of a population in a specific area and said position of each of said first series of data entries comprises a representative position of said specific area.

55. The system of claim 54, wherein said specific area comprises at least one of a postal code area, an area code area, a forward sortation area, a local directory unit area, a dissemination area, an enumeration area, a census block, a census block group, a community, a residential block and a municipality.

56. The system of claim 54, wherein said statistically clustered market data comprises at least one of an average spending per dwelling in said specific area, an average age of said population in said specific area, a number of homes in said specific area, an average income in said specific area, an average age of homes in said specific area.

57. The system of claim 54, wherein each specific area corresponds to one distribution zone such that only one semaphore is mapped for each distribution zone on said map.

58. The system of claim 51, wherein each of said first series of entries comprises location information related to said location, said processor, having communicative access to said location information, being adapted to associate said location information for each of said first series of entries with said semaphore to provide access thereto via said map.

59. The system of claim 51, the system further comprising a portable positioning device for acquiring a QC position of at least one hardcopy media delivery location, said processor, having communicative access to said QC position, being adapted to assign a positive delivery status marker thereto and placing said marker on said map.

60. The system of claim 59, wherein said positioning device comprises a GPS device and wherein said QC position is acquired thereby and stored thereon via a GPS waypoint communicatively transferred to said database.

61. The system of claim 59, said portable positioning device further being used for acquiring a plurality of tracking positions in a vicinity of said delivery location, said processor having access to said tracking positions being adapted to assign a tracking marker to at least one of said tracking positions and placing said tracking marker on said map.
